(19) United States
(12) Patent Application Publication
(10) Pub. No.: US 2026/0335183 A1
(43) Pub. Date: Oct. 29, 2026

(54) PORTABLE CPR DEVICE

(71) Applicant: Blue Robin Inc., Seoul (KR)

(72) Inventors: Jae Heung PARK, Seoul (KR); Sung Moon HUR, Seoul (KR); Gil Joon SEO, Seoul (KR); Kyung Soo KIM, Seoul (KR); Tae Gyun KIM, Seoul (KR); Jung Chan LEE, Seoul (KR); Jae Hoon SIM, Seoul (KR)

(73) Assignee: Blue Robin Inc., Seoul (KR)

(21) Appl. No.: 19/112,032

(22) PCT Filed: Aug. 2, 2023
(86) PCT No.: PCT/KR2023/011287

§ 371 Date: Jul. 17, 2026

(30) Foreign Application Priority Data
Sep. 16, 2022 (KR) 10-2022-0117173
Aug. 1, 2023 (KR) 10-2023-0100504

(51) Int. Cl. A61H 31/00

(52) U.S. Cl. CPC A61H 31/006; A61H 31/008; A61H 2201/0192; A61H 2201/1664; A61H 2203/0456

(57) ABSTRACT

A portable cardiopulmonary resuscitation device comprises: a main body; a compression module connected to the main body and configured to apply pressure to a patient's chest in a first direction toward a lower side of the main body; a first connection frame rotatably connected to a first portion of the main body about a first rotation axis, extending in a first longitudinal direction from the first portion, and including a first connection portion formed at an end thereof; a second connection frame rotatably connected to a second portion of the main body, opposite to the first portion, about a second rotation axis, extending in a second longitudinal direction from the second portion, and including a second connection portion formed at an end thereof; and a fixation frame detachably coupled at both ends to the first connection portion of the first connection frame and the second connection portion of the second connection frame, the fixation frame being disposed on the ground to support the back of the patient.

### TECHNICAL FIELD

The following disclosure relates to a portable cardiopulmonary resuscitation (CPR) device.

### BACKGROUND ART

Cardiopulmonary resuscitation (CPR) is an essential emergency procedure when cardiac function ceases or stops. If prompt action is not taken, brain damage begins after four minutes, leading to severe damage to other vital organs, and survival rates drop sharply after ten minutes. It is generally known that for every minute of delay in defibrillation, the survival rate decreases by 7-10%, whereas performing CPR reduces this decrease to 2.5-5%. Properly administered CPR significantly improves survival rates. However, even trained individuals often become flustered when faced with an actual CPR situation, preventing them from performing CPR correctly.

According to the latest CPR guidelines, it is necessary to maintain a compression depth of at least 5 cm and a rate of more than 100 compressions per minute while ensuring sufficient decompression between compressions to maintain adequate cardiac output. This improves coronary perfusion pressure, increases the likelihood of return of spontaneous circulation (ROSC), and reduces damage to vital organs such as the brain and lungs. To achieve optimal CPR and provide continuous chest compressions without fatigue, a system capable of exploring and maintaining the best possible CPR performance is required.

The aforementioned background art comprises the knowledge possessed or acquired by the inventor during the process of deriving the present disclosure. However, it cannot necessarily be regarded as publicly known technology that was disclosed to the general public before the filing of the present application.

### DISCLOSURE OF THE INVENTION

### Problems to be Solved

An objective of an embodiment is to provide a portable cardiopulmonary resuscitation (CPR) device that enables effective CPR on a patient in an emergency situation by offering high portability and adaptability for use.

An objective of an embodiment is to provide a portable CPR device capable of achieving effective chest compressions by allowing the compression position on the patient′ s chest to be easily adjusted.

An objective of an embodiment is to provide a portable CPR device capable of performing efficient chest compression operations by measuring and analyzing the patient's vital signs in real time during the chest compression process.

### Means for Solving the Problem

A portable cardiopulmonary resuscitation (CPR) device according to an embodiment may include:
a main body; a compression module connected to the main body and configured to apply pressure to a patient's chest in a first direction toward the lower side of the main body; a first connection frame rotatably connected to a first portion of the main body about a first rotation axis, extending in a first longitudinal direction from the first portion, and including a first connection portion formed at an end thereof; a second connection frame rotatably connected to a second portion of the main body, which is opposite to the first portion, about a second rotation axis, extending in a second longitudinal direction from the second portion, and including a second connection portion formed at an end thereof; and a fixation frame detachably coupled at both ends to the first connection portion of the first connection frame and the second connection portion of the second connection frame, the fixation frame being configured to be placed on the ground to support the patient's back.

In an embodiment, the main body may include an opening formed to penetrate in the first direction. The compression module may be disposed in the opening.

In an embodiment, the compression module may include a chest compressor whose horizontal position on a plane perpendicular to the first direction is adjustable with respect to the main body, and which is configured to repeatedly compress the patient's chest.

In an embodiment, the chest compressor may include:
a compression member configured to contact the patient′ s chest; and an actuator configured to reciprocate the compression member along the first direction.

In an embodiment, the compression module may further include an input handle that is grippable by a user and configured to adjust the position of the chest compressor.

In one embodiment, the compression module may be connected to the chest compressor and may further include at least one position adjustment unit for changing the horizontal position of the chest compressor relative to the main body.

In one embodiment, the at least one position adjustment unit may include:
a first position adjustment unit, which is rotatably connected to both a first fixed shaft parallel to the first direction and the compression module, with reference to a plane perpendicular to the first direction, and is configured to adjust the spacing between the first fixed shaft and the compression module; and a second position adjustment unit, which is rotatably connected to both a second fixed shaft parallel to the first direction and the compression module, and is configured to adjust the spacing between the second fixed shaft and the compression module.

In an embodiment, the at least one position adjustment unit may include:
a first fixing shaft arranged parallel to the first direction and rotatably connected to a plane perpendicular to the first direction and to the compression module, and a first position adjustment unit configured to adjust the spacing between the first fixing shaft and the compression module.

Additionally, it may include:
a second fixing shaft arranged parallel to the first direction and rotatably connected to the compression module, and a second position adjustment unit configured to adjust the spacing between the second fixing shaft and the compression module.

In an embodiment, the compression module may further include the first position adjustment unit, which may include:
a first rotational link rotatable about the first fixing shaft parallel to the first direction, and a first connection link having one end rotatably connected to the first rotational link about a first connection shaft parallel to the first fixing shaft, and the other end rotatably connected to the compression module about a first central shaft parallel to the first connection shaft.

In an embodiment, the compression module may further include the second position adjustment unit, which may include:
a second rotational link rotatable about the second fixing shaft parallel to the first direction, and a second connection link having one end rotatably connected to the second rotational link about a second connection shaft parallel to the second fixing shaft, and the other end rotatably connected to the compression module about a second central shaft parallel to the second connection shaft.

In an embodiment, the compression module may further include an actuator for operating the position adjustment unit.

In an embodiment, the compression module may further include a stopper for restricting the operation of either the first position adjustment unit or the second position adjustment unit.

In an embodiment, the first connection frame and the second connection frame may be rotatable relative to the main body such that:
in a first state, the first connection portion and the second connection portion are positioned on the lower side of the main body and are engageable with the fixation frame; or in a second state, the first connection portion and the second connection portion are positioned on the upper side of the main body.

In an embodiment, in the first state, the main body, the first connection frame, the second connection frame, and the fixation frame may form a seating space in which the patient's body can be positioned.

In an embodiment, in the second state, the first connection portion of the first connection frame and the second connection portion of the second connection frame may have a minimum spacing therebetween.

In an embodiment, the first rotation axis and the second rotation axis may form an intersection below the main body.

In an embodiment, the first rotation axis and the second rotation axis may be either coincident or parallel to each other.

In an embodiment, the fixation frame may include:
a first insertion portion and a second insertion portion formed at both ends, respectively, into which the first connection portion and the second connection portion are inserted; and a pair of fixing units respectively disposed within the first insertion portion and the second insertion portion to detachably fix the first connection portion and the second connection portion inserted therein.

### Effects of the Invention

A portable cardiopulmonary resuscitation (CPR) device according to an embodiment enables effective CPR on a patient in an emergency situation by providing high portability and adaptability for use.

A portable CPR device according to an embodiment allows easy adjustment of the chest compression position on the patient′ s chest, thereby achieving effective chest compression.

A portable CPR device according to an embodiment enables the efficient performance of chest compression operations during the chest compression process.

### BRIEF DESCRIPTION OF THE DRAWINGS

FIG. 1 is a usage state diagram of a portable cardiopulmonary resuscitation (CPR) device according to an embodiment.

FIG. 2 is a perspective view showing a first state of the portable CPR device according to an embodiment.

FIG. 3 is a perspective view illustrating a process in which a support frame is detached from the portable CPR device according to an embodiment.

FIG. 4 is a perspective view showing a second state of the portable CPR device according to an embodiment.

FIG. 5 is a diagram illustrating a camera, battery, and sensor unit of the portable CPR device according to an embodiment.

FIG. 6 is a block diagram of the portable CPR device according to an embodiment.

FIG. 7 is a perspective view of the portable CPR device according to an embodiment.

FIGS. 8 and 9 are diagrams showing the compression module viewed from different directions in the portable CPR device according to an embodiment.

FIGS. 10 and 11 are diagrams illustrating a process in which the connection frame is mounted on the support frame in the portable CPR device according to an embodiment.

### DETAILED DESCRIPTION FOR CARRYING OUT THE INVENTION

Hereinafter, embodiments will be described in detail with reference to the accompanying drawings. However, various modifications may be made to the embodiments, and the scope of rights of the patent application is not limited or restricted by these embodiments. It should be understood that all modifications, equivalents, and substitutions related to the embodiments fall within the scope of rights.

The terms used in the embodiments are merely for the purpose of description and should not be construed as limiting. Unless the context clearly dictates otherwise, singular expressions include plural meanings. In this specification, terms such as “include” or “have” are intended to specify the presence of the features, numbers, steps, operations, components, elements, or combinations thereof described in the specification, and should not be interpreted as precluding the possibility of the presence or addition of one or more other features, numbers, steps, operations, components, elements, or combinations thereof.

Unless otherwise defined, all terms used herein, including technical and scientific terms, have the same meaning as commonly understood by those skilled in the technical field to which the embodiments pertain. Terms that are generally defined in commonly used dictionaries should be interpreted as having meanings consistent with the context of the related technology and should not be construed in an idealized or excessively formal manner unless explicitly defined in the present application.

Furthermore, in the description with reference to the accompanying drawings, the same reference numerals are assigned to identical components regardless of the figure number, and redundant descriptions thereof will be omitted. If it is determined that a detailed explanation of related known technologies may unnecessarily obscure the essence of the embodiments, such detailed explanations will be omitted.

Additionally, in describing the components of the embodiments, terms such as first, second, A, B, (a), and (b) may be used. These terms are merely intended to distinguish one component from another and do not limit the essence, order, or sequence of the corresponding components.

When a component is described as being “connected,” “coupled,” or “attached” to another component, it should be understood that the component may be directly connected or attached to the other component, but it may also be indirectly connected or attached with an intervening component therebetween.

Components included in one embodiment and components with common functionality will be described using the same terminology in other embodiments. Unless stated otherwise, descriptions provided in one embodiment are applicable to other embodiments as well, and repetitive descriptions will be omitted where they overlap.

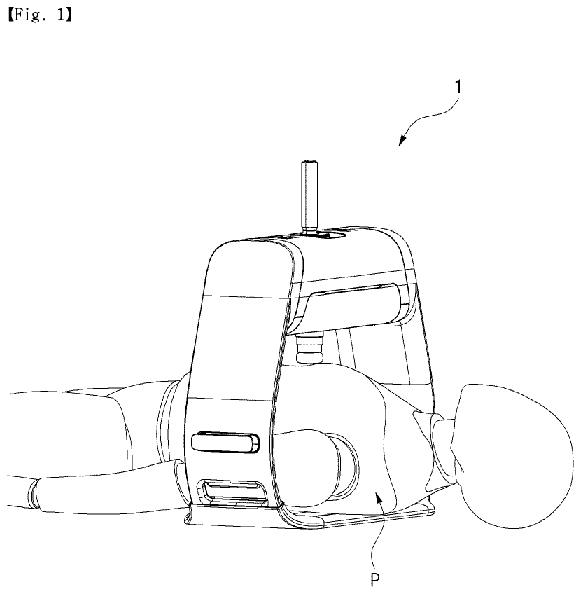

FIG. 1 is a usage state diagram of a portable cardiopulmonary resuscitation (CPR) device according to an embodiment.

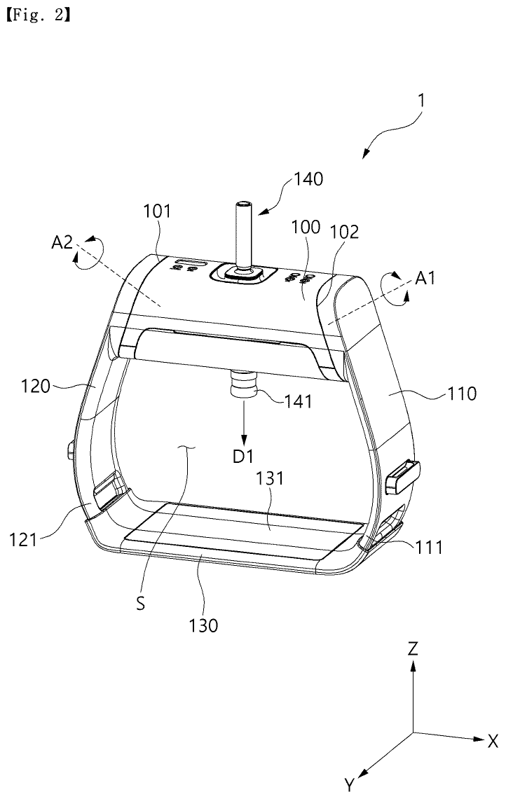

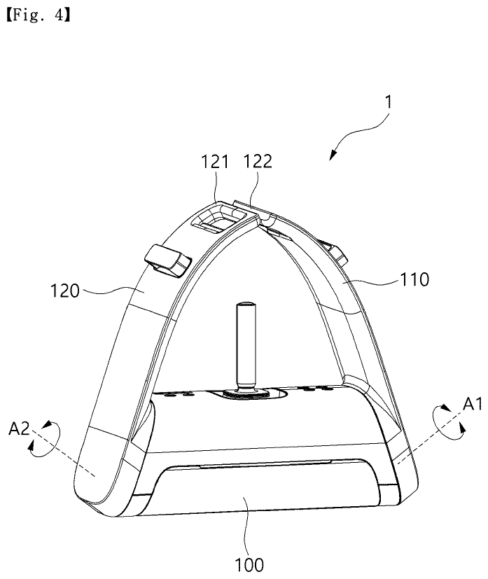

Referring to FIG. 1, a portable CPR device (1) according to an embodiment may be used to perform cardiopulmonary resuscitation (CPR) on a patient (P). The portable CPR device (1) may have high portability, allowing its state to change depending on whether it is in use. For example, during use on a patient (P), the portable CPR device (1) may be in a usage state, as shown in FIG. 2 (e.g., the first state of FIG. 2), whereas during storage or transportation, it may be in a portable state, as shown in FIG. 4 (e.g., the second state of FIG. 4).

In an embodiment, in the usage state as shown in FIG. 1, the portable CPR device (1) may repeatedly perform chest compressions on a patient (P) lying on the ground at a predetermined depth and cycle. In an embodiment, the portable CPR device (1) may adjust the chest compression position optimally based on the patient's (P) condition, such as body size and individual heart location. In an embodiment, during storage or transport, the portable CPR device (1) may change its state so that it can be easily gripped by a user (e.g., an individual operating the CPR device (1)).

For instance, the portable CPR device (1) may provide high portability and ease of use, allowing for rapid and accurate CPR operations on a patient (P) in an emergency situation.

FIG. 2 is a perspective view showing the first state of the portable CPR device (1) according to an embodiment.

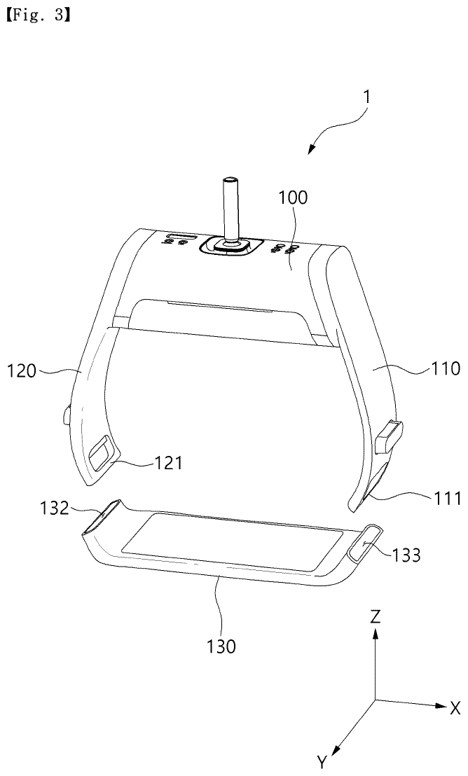

FIG. 3 is a perspective view illustrating a process in which a connection frame is detached from the portable CPR device (1) according to an embodiment.

FIG. 4 is a perspective view showing the second state of the portable CPR device (1) according to an embodiment.

Referring to FIGS. 2 to 4, a portable cardiopulmonary resuscitation (CPR) device (1) according to an embodiment may include a main body (100), a compression module (140), a first connection frame (110), a second connection frame (120), and a fixation frame (130).

In an embodiment, the main body (100) may be implemented in various forms and may include an input interface (not shown) for receiving user commands. The main body (100) may accommodate various components for performing CPR on a patient (P), such as the compression module (140), a battery (170), and a camera (160). Additionally, the main body (100) may include a display unit (not shown) disposed on its surface for displaying various information, such as operational data of the portable CPR device (1) and sensing data related to the patient (P). For example, the display unit may include a display or a speaker to provide visual and auditory information.

In an embodiment, in the first state (FIG. 2), the main body (100) may be positioned at an elevated location above the ground. In this case, as shown in FIG. 1, when the portable CPR device (1) is used on a patient (P), the main body (100) may be located above the chest of the patient (P). Conversely, in the second state (FIG. 4), the main body (100) may be positioned on the ground. That is, depending on the state of the portable CPR device (1), the relative position of the main body (100) may change accordingly.

In an embodiment, the main body (100) may have an elongated structure extending in a specific direction (e.g., the X-axis direction). In this case, the first connection frame (110) and the second connection frame (120) may be connected to opposite sides of the main body (100). The first connection frame (110) and the second connection frame (120) may be connected in opposite directions relative to the main body (100).

The main body (100) may include:

A first portion (102) to which the first connection frame (110) is connected (e.g., the portion of the main body (100) extending toward the +X direction), and

A second portion (101) opposite to the first portion (102), where the second connection frame (120) is connected (e.g., the portion of the main body (100) extending toward the −X direction).

In an embodiment, the main body (100) may include an opening that penetrates through it in a first direction (e.g., Z-axis direction). The opening may be centrally located along the elongation direction of the main body (100). When the main body (100) is in the first state, the opening may be aligned with the fixation frame (130) when viewed along the first direction.

In an embodiment, the compression module (140) may be disposed in the opening and may be covered by other components to prevent its internal elements (e.g., compression member, input handle (1413), etc.) from being externally exposed. Further details of this structure are omitted here.

In an embodiment, the compression module (140) may be connected to the main body (100). For example, it may be positioned within the opening of the main body (100). The compression module (140) may be configured to pressurize the chest of the patient (P) in the first direction (e.g., downward toward the fixation frame (130)).

Further details of the compression module (140) will be described later.

In one embodiment, the first connection frame (110) and the second connection frame (120) may each be rotatably connected to the main body (100). In one embodiment, the first connection frame (110) may be connected to the first portion (102) of the main body (100) and may rotate about the first rotation axis (A1) relative to the main body (100). In one embodiment, the first connection frame (110) may extend in the first longitudinal direction from the first portion (102) of the main body (100). The extended end of the first connection frame (110) (e.g., the end of the first connection frame (110) extending in the −Z direction in FIG. 2) may be formed with a first connection portion (111).

In one embodiment, the first connection frame (110) may be connected to the fixation frame (130) via the first connection portion (111). For example, the first connection portion (111) may be formed with a connection rod that is inserted and fastened into a first insertion portion of the fixation frame (130), which will be described later.

In one embodiment, the second connection frame (120) may be connected to the second portion (101) of the main body (100) and may rotate about the second rotation axis (A2) relative to the main body (100). In one embodiment, the second connection frame (120) may extend in the second longitudinal direction from the second portion (101) of the main body (100). The extended end of the second connection frame (120) (e.g., the end of the second connection frame (120) extending in the −Z direction in FIG. 2) may be formed with a second connection portion (121). In one embodiment, the second connection frame (120) may be connected to the fixation frame (130) via the second connection portion (121). For example, the second connection portion (121) may be formed with a connection rod that is inserted and fastened into a second insertion portion of the fixation frame (130), which will be described later.

In one embodiment, the first connection frame (110) and the second connection frame (120) may each rotate relative to the main body (100) to change the state of the portable cardiopulmonary resuscitation device (1) to either the first state or the second state. In one embodiment, the first connection frame (110) and the second connection frame (120) may rotate relative to the main body (100) such that the first connection portion (111) and the second connection portion (121) are positioned on the lower side of the main body (100) and engageable with the fixation frame (130) in the first state (e.g., FIG. 2). In one embodiment, the first connection frame (110) and the second connection frame (120) may rotate relative to the main body (100) such that the first connection portion (111) and the second connection portion (121) are positioned on the upper side of the main body (100) in the second state (e.g., FIG. 4).

In one embodiment, the first connection frame (110) and the second connection frame (120) may be connectable to the fixation frame (130) in the first state of the portable cardiopulmonary resuscitation device (1). In this case, the main body (100), the first connection frame (110), the second connection frame (120), and the fixation frame (130) may form a seating space in which the body of the patient (P) can be positioned. For example, the portable cardiopulmonary resuscitation device (1) may surround the body of the patient (P) around the seating space. In one embodiment, before transitioning from the first state to the second state, as shown in FIG. 2, the connection state between the fixation frame (130) and the first connection frame (110) and the second connection frame (120) may be released. In one embodiment, the first connection frame (110) and the second connection frame (120) may rotate relative to the main body (100) to bring the portable cardiopulmonary resuscitation device (1) into the second state. In this case, when the portable cardiopulmonary resuscitation device (1) is in the second state, the first connection frame (110) and the second connection frame (120) may function as carrying handles that can be gripped by a user. For example, gripping grooves may be formed at the ends of the first connection frame (110) and the second connection frame (120) so that they can be gripped by the user's hand.

In one embodiment, the first connection frame (110) and the second connection frame (120) may have a variable distance between them depending on their rotational position relative to the main body (100). In one embodiment, the first rotation axis (A1) and the second rotation axis (A2) may form a single intersection below the main body (100). For example, the first rotation axis (A1) of the first connection frame (110), which rotates relative to the main body (100), may be inclined with respect to the ground (e.g., XY plane). In this case, the first rotation axis (Al) may be inclined upward from the main body (100) toward the first connection frame (110) with respect to the ground. Similarly, the second rotation axis (A2) of the second connection frame (120), which rotates relative to the main body (100), may be inclined with respect to the ground. In this case, the second rotation axis (A2) may be inclined upward from the main body (100) toward the second connection frame (120) with respect to the ground. In this configuration, the distance between the first connection frame (110) and the second connection frame (120) may be closer in the second state than in the first state of the portable cardiopulmonary resuscitation device (1).

In one embodiment, the first connection frame (110) and the second connection frame (120) may have a streamlined curvature along their respective longitudinal directions. For example, based on the first state as shown in FIG. 2, the distance between the first connection frame (110) and the second connection frame (120) may increase as they extend away from the main body (100) but may then converge at the first connection portion (111) and the second connection portion (121). In this case, the first connection portion (111) and the second connection portion (121) may form a minimum spacing in the second state of the portable cardiopulmonary resuscitation device (1).

In another embodiment, the first rotation axis (A1) and the second rotation axis (A2) may either coincide or be parallel to each other. In this case, the first connection frame (110) and the second connection frame (120) may have a curved shape along their longitudinal direction to facilitate gripping by the user when the portable cardiopulmonary resuscitation device (1) is in the second state.

In one embodiment, the fixation frame (130) may be detachably coupled to the first connection frame (110) and the second connection frame (120). For example, in the first state of the portable cardiopulmonary resuscitation device (1), the fixation frame (130) may be positioned on the ground, and its both ends may be fastened to the first connection portion (111) and the second connection portion (121), thereby supporting the back of the patient (P) positioned in the seating space. When the fixation frame (130) is fastened to the first connection portion (111) and the second connection portion (121), it may serve as a support stand, allowing the first connection frame (110), the second connection frame (120), and the main body (100) to be positioned upright on the ground.

The surface of the fixation frame (130), particularly the area in contact with the patient's (P) body, may be provided with a support portion (131) to comfortably support the patient's (P) body. The support portion may be made of compressible materials such as sponge or rubber.

In one embodiment, during the transition of the portable cardiopulmonary resuscitation device (1) from the first state to the second state, the fixation frame (130) may be separated from the first connection frame (110) and the second connection frame (120), as shown in FIG. 3.

Thus, when the fixation frame (130) is detachably coupled to the first connection frame (110) and the second connection frame (120), cardiopulmonary resuscitation (CPR) for an unconscious patient (P) can be more easily implemented. For example, when the portable cardiopulmonary resuscitation device (1) is used on an unconscious patient (P), the fixation frame (130) may first be placed on the ground, and then the patient (P) may be positioned on the upper surface of the fixation frame (130), such as on the support portion. Subsequently, the first connection frame (110) and the second connection frame (120) may be coupled to the fixation frame (130), allowing the patient (P) to be positioned within the seat ing space.

In one embodiment, when viewed in the first direction (e.g., Z-axis direction), the fixation frame (130) overlaps with the compression module (140) for chest compressions of the patient (P). Therefore, the fixation frame (130) may also function as a reference for positioning the patient's (P) chest area for chest compressions.

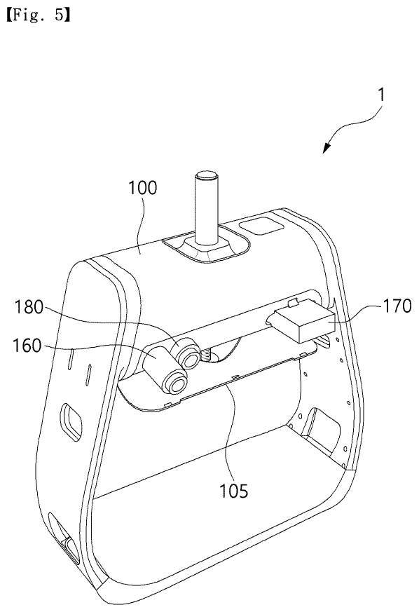

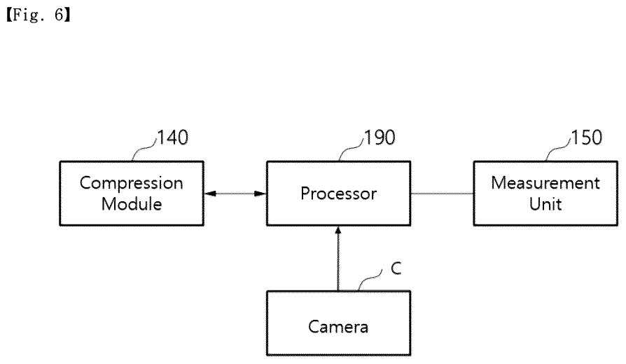

For example, as shown in FIGS. 2 to 4, through the rotational movement of the first connection frame (110) and the second connection frame (120) relative to the main body (100), as well as the coupling operation of the fixation frame (130) to the first connection frame (110) and the second connection frame (120), the state of the portable cardiopulmonary resuscitation device (1) can be quickly and easily changed. FIG. 5 is a diagram illustrating a compression unit extension, a battery, and a measurement unit of a portable cardiopulmonary resuscitation device (1) according to one embodiment, and FIG. 6 is a block diagram of a portable cardiopulmonary resuscitation device according to one embodiment. Referring to FIGS. 5 and 6, a portable cardiopulmonary resuscitation device (1) according to one embodiment may further include a compression unit extension (160), a battery (170), a measurement unit (150), and a processor (190) disposed inside the main body (100).

In one embodiment, the compression unit extension (160), the battery (170), and the measurement unit (150) may be covered by a protective cover and selectively exposed to the outside as needed. For example, the measurement unit (150) may be exposed externally when the portable cardiopulmonary resuscitation device (1) is in use to detect the condition of the patient (P).

In one embodiment, the processor (190) may be provided inside the main body (100).

However, the locations of each component shown in the drawings are illustrative and are not limited thereto.

In one embodiment, the portable cardiopulmonary resuscitation device (1) may further include a camera (C). In one embodiment, the camera (C) may capture video of the chest compressor (141), which will be described later, compressing the chest of the patient (P) positioned in the seating space.

In one embodiment, the video captured by the camera (C) may be displayed through a display or analyzed by the processor (190). In one embodiment, by capturing the chest of the patient (P), the camera (C) may provide information to the processor (190) to explore the appropriate chest compression position for the patient (P). In one embodiment, the camera (C) may not be provided in the portable cardiopulmonary resuscitation device (1) but may instead be used as an external device.

In one embodiment, the measurement unit (150) may sense information related to the chest compression operation performed on the patient (P). For example, the measurement unit (150) may include one or more sensors, such as a pressure sensor, torque sensor, or load cell, for measuring in real-time the force or torque generated when the chest compressor (141), which will be described later, contacts the patient (P). In one embodiment, the measurement unit (150) may include one or more sensors for detecting the biometric information of the patient (P). For example, the measurement unit (150) may include one or more sensors for measuring various bio-signals of the patient (P), such as cardiac output, blood pressure, electrocardiogram, and blood oxygen saturation levels.

In one embodiment, the processor (190) may control the operation of the portable cardiopulmonary resuscitation device (1). In one embodiment, based on the information detected through the camera (C) and the measurement unit (150), the processor (190) may determine the optimal compression conditions for the patient (P). For example, the processor (190) may detect an appropriate initial chest compression point for the patient (P) through the camera (C) and adjust the position of the compression module (140) so that the chest compressor (141) compresses the detected initial chest compression point. In one embodiment, based on the information detected through the measurement unit (150), such as the cardiac output of the patient (P), the processor (190) may determine and provide the conditions that offer the most effective chest compressions for the patient (P). The processor (190) may determine the compression conditions and compression position of the chest compressor (141) for the patient (P) based on the detected information. The setting of the chest compression position and operating conditions by the processor (190) may be performed according to a predetermined algorithm. The description of this process is omitted.

In one embodiment, the battery (170) may supply power for operating the portable cardiopulmonary resuscitation device (1). In one embodiment, the battery (170) may be attachable to or detachable from the main body (100).

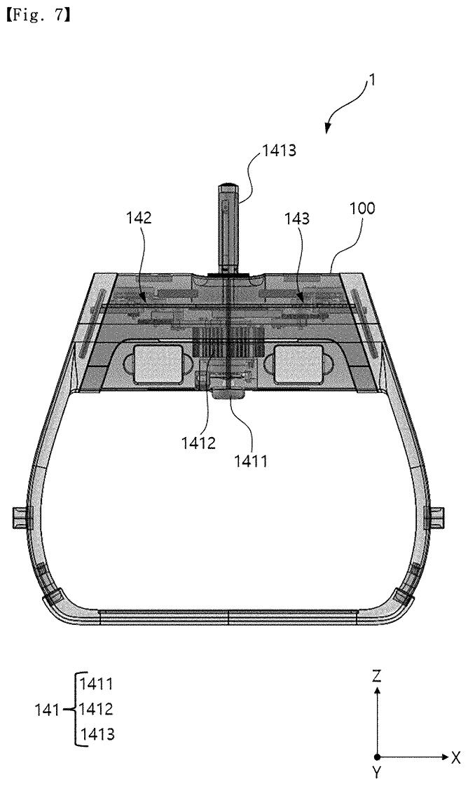

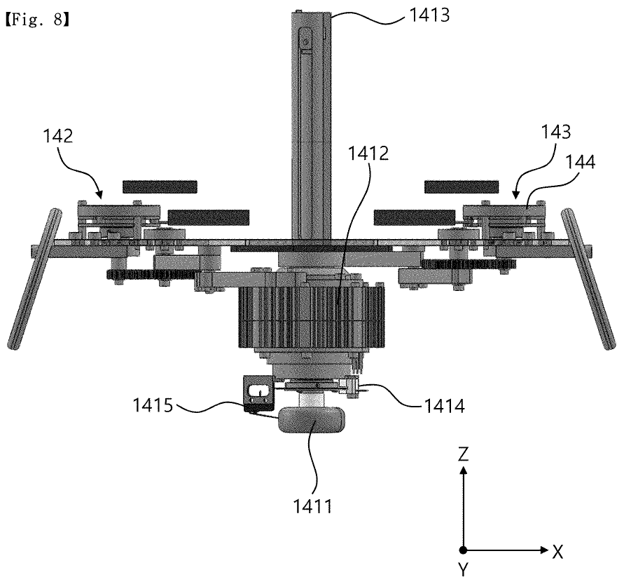

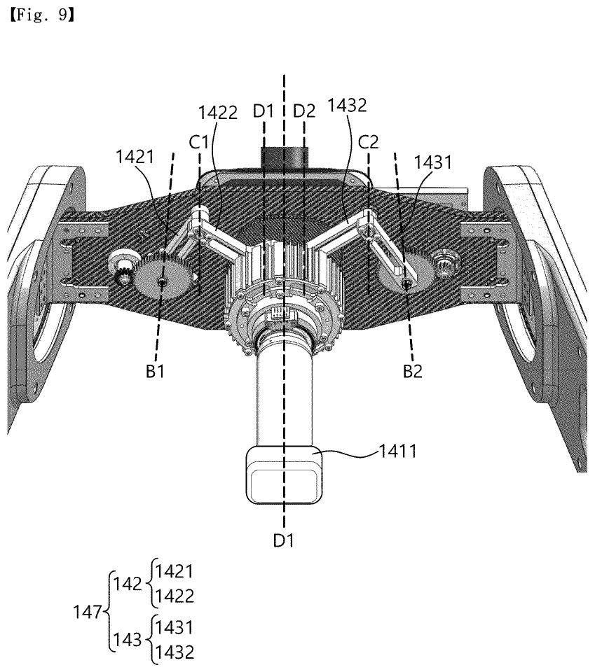

FIG. 7 is a perspective view of a portable cardiopulmonary resuscitation device (1) according to one embodiment, and FIGS. 8 and 9 are diagrams showing the compression module (140) viewed from different directions according to one embodiment.

Referring to FIGS. 7, 8, and 9, the portable cardiopulmonary resuscitation device (1) may compress a part of the patient's (P) body, for example, the chest of the patient (P) positioned on the fixation frame (130), through the compression module (140). In one embodiment, the compression module (140) may be positioned within an opening of the main body (100).

In one embodiment, the compression module (140) may operate when the portable cardiopulmonary resuscitation device (1) is in the first state (e.g., the first state of FIG. 2). In one embodiment, the compression module (140) may apply pressure to the chest of the patient (P) in a first direction toward the lower side of the main body (100) (e.g., the −Z direction in FIG. 7). The compression module (140) may change the compression position on the patient (P) positioned on a fixed location, such as the fixation frame (130).

In one embodiment, the compression module (140) may include a chest compressor (141) that operates to compress the patient's (P) body, an input handle (1413), one or more position adjustment units to adjust the position of the chest compressor (141) relative to the main body (100), and a stopper (144).

In one embodiment, the chest compressor (141) may be position-adjustable relative to the main body (100). When the portable cardiopulmonary resuscitation device (1) is in the first state, the horizontal position of the chest compressor (141) may be adjustable on a plane perpendicular to the first direction (e.g., the XY plane in FIG. 7). Hereinafter, for convenience, the position of the chest compressor (141) on a plane perpendicular to the first direction will be referred to as the horizontal position. As the horizontal position of the chest compressor (141) relative to the main body (100) changes, the area of the patient (P) subjected to compression may also change.

In one embodiment, the horizontal position of the chest compressor (141) relative to the main body (100) may be adjusted to correspond to the optimal compression site for the patient (P) detected by the processor (190).

In one embodiment, the chest compressor (141) may include a compression member (1411), an actuator (1412), an encoder (1414), and a switch (1415). The compression member (1411) may be positioned at the lower end of the chest compressor (141). The compression member (1411) may change its position in the first direction relative to the main body (100) according to the operation of the chest compressor (141). For example, the compression member (1411) may reciprocate along the first direction and its opposite direction to repeatedly compress the chest of the patient (P) according to the operation of the chest compressor (141).

In one embodiment, the compression member (1411) may contact the patient's (P) chest through its lower end. In another embodiment, a separate contact member may be replaceably connected to the lower end of the compression member (1411) for contact with the patient's (P) chest.

In one embodiment, the compression member (1411) may reciprocate along the first direction according to the operation of the actuator (1412). The actuator (1412) may operate based on signals from the processor (190) to apply pressure to the patient's (P) chest at a predetermined cycle and pressure.

In one embodiment, the chest compressor (141) may include an encoder (1414) for detecting signals related to the operation of the actuator (1412) and a switch (1415) for controlling the operation of the actuator (1412).

In one embodiment, the input handle (1413) may be connected to the upper end of the chest compressor (141). For example, the input handle (1413) may protrude upward from the main body (100).

In one embodiment, the input handle (1413) may be grasped by a user and moved horizontally together with the chest compressor (141) by applying force. In one embodiment, the input handle (1413) may receive a position adjustment signal from the user to adjust the horizontal position of the chest compressor (141). The position adjustment signal may be a force applied to the handle by the user.

For example, when the input handle (1413) receives a first signal (e.g., a signal corresponding to pressing or pulling the input handle (1413)), it may activate or release a stopper (144), which will be described later. This allows the position adjustment unit to adjust the horizontal position of the chest compressor (141) or fix its horizontal position.

In one embodiment, when the input handle (1413) receives a position adjustment signal from the user (e.g., a signal corresponding to moving the input handle (1413) horizontally), the position adjustment unit may operate in response to the signal from the input handle (1413) to adjust the horizontal position of the chest compressor (141) relative to the main body (100).

In one embodiment, at least one position adjustment unit may be connected to the chest compressor (141) and may function to change the horizontal position of the chest compressor (141) relative to the main body (100).

In one embodiment, the position adjustment unit may include a first position adjustment unit (142) and a second position adjustment unit (143). However, only one of the first position adjustment unit (142) or the second position adjustment unit (143) may be provided.

In one embodiment, the first position adjustment unit (142) may adjust the horizontal position of the chest compressor (141) with respect to the first fixed shaft (B1), which is at a fixed position on a plane perpendicular to the first direction. In one embodiment, the first fixed shaft (B1) may be parallel to the first direction (i.e., parallel to the Z-axis). In one embodiment, the first position adjustment unit (142) may be rotatably connected to both the first fixed shaft (B1) and the chest compressor (141), respectively. The first position adjustment unit (142) may adjust the distance between the first fixed shaft (B1) and the chest compressor (141). In this case, depending on the operation of the first position adjustment unit (142), the horizontal position of the chest compressor (141) with respect to the first fixed shaft (B1) may be changed as the angle and distance vary.

In one embodiment, the first position adjustment unit (142) may include a first rotation link (1421) rotatably connected to the first fixed shaft (B1), and a first connection link (1422) rotatably connected to both the first rotation link (1421) and the chest compressor (141). In one embodiment, the first rotation link (1421) may rotate about the first fixed shaft (B1). The first rotation link (1421) may, for example, be connected to a gear arranged on the first fixed shaft (B1) and rotate about the first fixed shaft (B1) in accordance with the operation of the gear. In one embodiment, the first connection link (1422) may be rotatably connected at its ends to the first rotation link (1421) and a first point of the chest compressor (141). The first connection link (1422) may be positioned on the first rotation link (1421) and rotate about a first connection shaft (C1) parallel to the first fixed shaft (B1). As the first rotation link (1421) rotates about the first fixed shaft (B1), the position of the first connection shaft (C1) may change. The first connection link (1422) may be positioned at a first point of the chest compressor (141) and rotate about a first central shaft (D1) parallel to the first connection shaft (C1).

With this structure, by rotating the first rotation link (1421) relative to the first fixed shaft (B1) and rotating the first connection link (1422) relative to the first rotation link (1421), the horizontal position of the chest compressor (141) may be adjusted without restriction within the main body (100).

In one embodiment, the second position adjustment unit (143) may adjust the horizontal position of the chest compressor (141) with respect to a fixed second fixed shaft (B2) on a plane perpendicular to the first direction. In one embodiment, the second fixed shaft (B2) may be parallel to the first direction (i.e., parallel to the Z-axis). In one embodiment, the second position adjustment unit (143) may be rotatably connected to both the second fixed shaft (B2) and the chest compressor (141), respectively. The second position adjustment unit (143) may adjust the distance between the first fixed shaft (B1) and the chest compressor (141). Therefore, as the angle and distance of the chest compressor (141) relative to the second fixed shaft (B2) change, the horizontal position of the chest compressor (141) may also change.

In one embodiment, the second position adjustment unit (143) may include a second rotation link (1431) rotatably connected to the second fixed shaft (B2), and a second connection link (1432) rotatably connected to both the second rotation link (1431) and the chest compressor (141). In one embodiment, the second rotation link (1431) may rotate about the second fixed shaft (B2). The second rotation link (1431) may, for example, be connected to a gear arranged on the second fixed shaft (B2) and rotate about the second fixed shaft (B2) in accordance with the operation of the gear. In one embodiment, the second connection link (1432) may be rotatably connected at its ends to the second rotation link (1431) and a second point of the chest compressor (141). The second connection link (1432) may be positioned on the second rotation link (1431) and rotate about a second connection shaft (C2) parallel to the second fixed shaft (B2). As the second rotation link (1431) rotates about the second fixed shaft (B2), the position of the second connection shaft (C2) may change. The second connection link (1432) may be positioned at a second point of the chest compressor (141) and rotate about a second central shaft (D2) parallel to the second connection shaft (C2). With this structure, by rotating the second rotation link (1431) relative to the second fixed shaft (B2) and rotating the second connection link (1432) relative to the second rotation link (1431), the horizontal position of the chest compressor (141) may be adjusted without restriction within the main body (100).

In one embodiment, the first position adjustment unit (142) and the second position adjustment unit (143) support the chest compressor (141) from both sides, enabling more stable adjustment of the horizontal position of the chest compressor (141). In one embodiment, at least one of the first position adjustment unit (142) and the second position adjustment unit (143) is connected to a second actuator (not shown) and can operate based on the power provided by the second actuator.

For example, the first position adjustment unit (142) may change the horizontal position of the chest compressor (141) by the operation of the second actuator. In this case, the second position adjustment unit (143) may support the chest compressor (141) while also operating in accordance with the position change of the chest compressor (141) caused by the operation of the first position adjustment unit (142). However, this is merely an example, and the first position adjustment unit (142) and the second position adjustment unit (143) may operate based on the force applied by the user via the input handle (1413). The following description will focus on the case where the first position adjustment unit (142) and the second position adjustment unit (143) operate based on the force applied by the user.

In one embodiment, the stopper (144) may be connected to at least one of the first position adjustment unit (142) and the second position adjustment unit (143). For example, a pair of stoppers (144) may be connected to the first position adjustment unit (142) and the second position adjustment unit (143), respectively. The stopper (144) may selectively restrict the operation of the first position adjustment unit (142) and the second position adjustment unit (143), preventing unintended changes in the horizontal position of the chest compressor (141). In one embodiment, the stopper (144) may mechanically operate through manual manipulation, but alternatively, it may operate automatically, for example, in response to an operation signal (e.g., a signal from the processor (190) or an operation signal input by the user) to restrict the operation of the position adjustment unit.

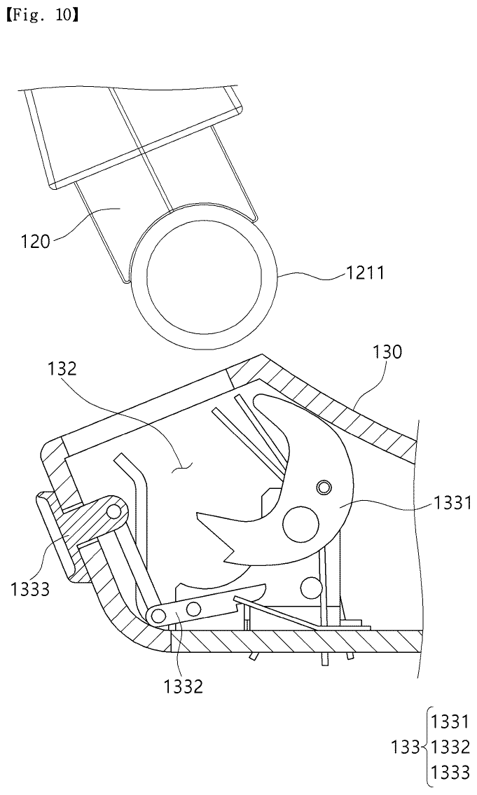

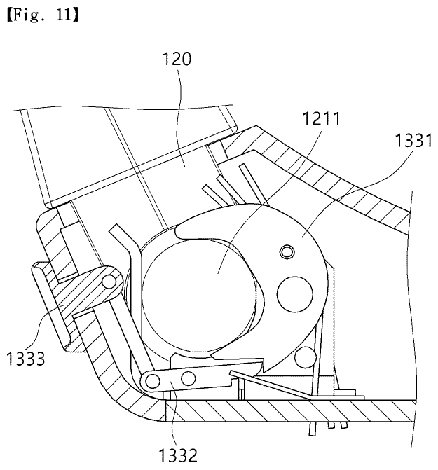

FIGS. 10 and 11 are diagrams illustrating the process of attaching the connection frame to the fixation frame according to one embodiment.

Referring to FIGS. 10 and 11, for the portable cardiopulmonary resuscitation device (1) to be used, a connection process between the first connection frame (110) and the second connection frame (120) and the fixation frame (130) is required. On the other hand, for storage or detachment of the portable cardiopulmonary resuscitation device (1), a process of detaching the first connection frame (110) and the second connection frame (120) from the fixation frame (130) is required.

The fixation frame (130) may include insertion parts (e.g., a first insertion part (132) and a second insertion part (133)) formed at both ends in the longitudinal direction. The first insertion part (132) may receive the first connection portion (111) of the first connection frame (110), and the second insertion part (133) may receive the second connection portion (121) of the second connection frame (120).

The insertion parts (132, 133) may be recessed into the inner side of the fixation frame (130), thereby forming an insertion space. In one embodiment, the fixation frame (130) may include a pair of fixing parts (133) (e.g., a first fixing part and a second fixing part), each positioned inside the pair of insertion parts. In one embodiment, the fixing part (133) may include a locking hook (1331) with an open side into which the connection portion can be inserted, a closing member (1332) that opens and closes the open section of the locking hook (1331), an elastic body that applies an elastic force to the closing member (1332) to close the locking hook (1331), and a lever (1333) connected to the closing member (1332) to operate the closing member (1332). In one embodiment, the lever (1333) is exposed to the outside of the fixation frame (130) and can be operated by the user. When the lever (1333) is operated, the closing member (1332) may move to open the open section of the locking hook (1331).

In one embodiment, when the connection portion (121) of the connection frame (120) is inserted into the insertion part (132), the connection portion (121) may push the closing member (1332) to open the open section of the locking hook (1331). When the connection portion (121) is seated inside the locking hook (1331), the closing member (1332) may move by the force of the elastic body to close the locking hook (1331).

Therefore, the connection portion (121) of the connection frame (120) can be fixed to the fixation frame (130). On the other hand, in one embodiment, during the process of detaching the connection frame (120) from the fixation frame (130), when the lever (1333) is pulled by the user, the closing member (1332) may move to open the locking hook (1331), allowing the connection portion (121) of the connection frame (120) to be disengaged from the locking hook (1331).

Through this structure, the connection and disconnection of the connection frame to and from the fixation frame (130) can be easily performed, enabling a quick and simple transition between different states of the portable cardiopulmonary resuscitation device (1).

Although the embodiments have been described with reference to limited figures as above, those skilled in the art can apply various technical modifications and variations based on the disclosed content. For example, the described technologies may be performed in a different sequence than described, and/or the components of the described system, structure, device, or circuit may be combined or arranged in a different manner than described, or substituted or replaced with other components or equivalents while still achieving appropriate results.

Accordingly, other implementations, other embodiments, and equivalents to the claims below also fall within the scope of the following claims.

### DESCRIPTION OF REFERENCE NUMERALS

1: Portable Cardiopulmonary Resuscitation Device
P: Patient
100: Main Body
110: First Connection Frame
120: Second Connection Frame
130: Fixation Frame
140: Compression Module
180: Compression Unit Extension

1. A portable cardiopulmonary resuscitation device, comprising:
a main body;
a compression module connected to the main body and configured to apply pressure to a patient's chest in a first direction toward a lower side of the main body;
a first connection frame rotatably connected to a first portion of the main body about a first rotation axis, extending in a first longitudinal direction from the first portion, and including a first connection portion formed at an end thereof;
a second connection frame rotatably connected to a second portion of the main body, opposite to the first portion, about a second rotation axis, extending in a second longitudinal direction from the second portion, and including a second connection portion formed at an end thereof; and
a fixation frame detachably coupled at both ends to the first connection portion of the first connection frame and the second connection portion of the second connection frame, the fixation frame being disposed on the ground to support the back of the patient.

2. The portable cardiopulmonary resuscitation device according to claim 1, wherein the main body includes an opening formed therethrough in the first direction, and
the compression module is disposed within the opening.

3. The portable cardiopulmonary resuscitation device according to claim 1, wherein
the compression module includes a chest compressor, wherein the horizontal position of the chest compressor on a plane perpendicular to the first direction is adjustable relative to the main body, and the chest compressor operates to repeatedly compress the patient's chest; and
the chest compressor includes:
a compression member configured to contact the patient's chest; and
an actuator configured to reciprocate the compression member along the first direction.

4. The portable cardiopulmonary resuscitation device according to claim 3, wherein
the compression module further includes an input handle grippable by a user and configured to adjust the position of the chest compressor.

5. The portable cardiopulmonary resuscitation device according to claim 3, wherein
the compression module is connected to the chest compressor and further includes at least one position adjustment unit for changing the horizontal position of the chest compressor relative to the main body; and
the at least one position adjustment unit includes:
a first position adjustment unit configured to adjust the spacing between a first fixed shaft, which is parallel to the first direction, and the chest compressor, the first fixed shaft and the chest compressor being rotatably connected to the first position adjustment unit on a plane perpendicular to the first direction; and
a second position adjustment unit configured to adjust the spacing between a second fixed shaft, which is parallel to the first direction, and the chest compressor, the second fixed shaft and the chest compressor being rotatably connected to the second position adjustment unit.

6. The portable cardiopulmonary resuscitation device according to claim 3, wherein
the compression module further includes a first position adjustment unit; and
the first position adjustment unit includes:
a first rotation link rotatable about a first fixed shaft parallel to the first direction; and
a first connection link having one end rotatably connected to the first rotation link about a first connection shaft parallel to the first fixed shaft, and the other end rotatably connected to the chest compressor about a first central shaft parallel to the first connection shaft.

7. The portable cardiopulmonary resuscitation device according to claim 6, wherein
the compression module further includes a second position adjustment unit; and
the second position adjustment unit includes:
a second rotation link rotatable about a second fixed shaft parallel to the first direction; and
a second connection link having one end rotatably connected to the second rotation link about a second connection shaft parallel to the second fixed shaft, and the other end rotatably connected to the chest compressor about a second central shaft parallel to the second connection shaft.

8. The portable cardiopulmonary resuscitation device according to claim 5, wherein
the compression module further includes an actuator for operating the position adjustment unit.

9. The portable cardiopulmonary resuscitation device according to claim 5, wherein
the compression module further includes a stopper for restricting the operation of either the first position adjustment unit or the second position adjustment unit.

10. The portable cardiopulmonary resuscitation device according to claim 1, wherein
the first connection frame and the second connection frame are rotatable with respect to the main body such that:
in a first state, the first connection portion and the second connection portion are positioned at a lower side of the main body and are engageable with the fixation frame; or in a second state, the first connection portion and the second connection portion are positioned at an upper side of the main body.

11. The portable cardiopulmonary resuscitation device according to claim 10, wherein
in the first state, the main body, the first connection frame, the second connection frame, and the fixation frame form a seating space in which the patient's body can be positioned.

12. The portable cardiopulmonary resuscitation device according to claim 10, wherein
in the second state, the first connection portion of the first connection frame and the second connection portion of the second connection frame are positioned at a minimum distance from each other.

13. The portable cardiopulmonary resuscitation device according to claim 1, wherein
the first rotation axis and the second rotation axis form an intersection at a lower side of the main body.

14. The portable cardiopulmonary resuscitation device according to claim 1, wherein
the first rotation axis and the second rotation axis coincide with or are parallel to each other.

15. The portable cardiopulmonary resuscitation device according to claim 1, wherein the fixation frame includes:
a first insertion part and a second insertion part formed at both ends thereof, into which the first connection portion and the second connection portion are respectively inserted; and
a pair of fixing units respectively disposed inside the first insertion part and the second insertion part and configured to detachably secure the first connection portion and the second connection portion inserted therein.
